(19) United States
(12) Patent Application Publication
(10) Pub. No.: US 2021/0333358 A1
(43) Pub. Date: Oct. 28, 2021

(54) RADAR MODULE AND METHOD OF ALIGNING THE SAME

(71) Applicant: LG Electronics Inc., Seoul (KR)

(72) Inventors: Sehwan PARK, Seoul (KR); Kwangwoon KIM, Seoul (KR); Bumki PARK, Seoul (KR)

(21) Appl. No.: 16/488,823

(22) PCT Filed: Nov. 21, 2018
(86) PCT No.: PCT/KR2018/014349

§ 371 Date: Aug. 26, 2019

(51) Int. Cl. G01S 7/40; G01S 13/931; H01Q 1/22

(52) U.S. Cl. CPC G01S 7/4026; H01Q 1/2283; G01S 13/931

(57) ABSTRACT

A radar module and method of aligning the same are proposed. Particularly, it is proposed that a radar module provided to a vehicle includes an antenna including a radio wave transmitting unit and a radio wave receiving unit, a position sensor detecting a distorted angle of the antenna, and a first Integrated Circuit (IC) connected to the position sensor, wherein if a prescribed condition is met, the first IC calculates a correction value for correcting the distorted angle of the antenna.

### TECHNICAL FIELD

The present invention relates to a radar module and method of aligning the same, and more particularly, to a method of correcting a distorted angle of a radar module provided to a vehicle and radar module therefor.

### BACKGROUND ART

A vehicle traditionally functions as a transportation means of a user, and provides user's driving convenience by being equipped with various sensors, electronic devices and the like for user's convenience. Particularly, many ongoing efforts are made to develop and research Advanced Driver Assistance System (ADAS) for user's driving convenience and autonomous vehicles.

As one of various sensors for providing user's driving convenience, a radar module is used. The radar module detects an object through a radio wave transmitter and a radio wave receiver and is used to detect a location of the detected object and a distance from the detected object and a relative velocity of the detected object.

Meanwhile, when a radar module is installed at a vehicle, it may be installed at an angle deviating from a normal angle due to various causes. Therefore, the demand for a method of measuring and correcting a distortion of a radar in comparison with a reference is rising.

### DISCLOSURE OF THE INVENTION

### Technical Task

As described above, an alignment method of detecting that a radar module is installed at an angle deviating from a normal angle in a process for installing the radar module at a vehicle and correcting the deviation is required. Accordingly, one technical task of the present invention is to provide a method of detecting a distorted angle of a radar module using a position sensor and correcting the distortion.

Technical tasks obtainable from the present invention are non-limited by the above-mentioned technical tasks. And, other unmentioned technical tasks can be clearly understood from the following description by those having ordinary skill in the technical field to which the present invention pertains.

### Technical Solutions

In one technical aspect of the present invention, provided herein is a radar module provided to a vehicle, the radar module including an antenna including a radio wave transmitting unit and a radio wave receiving unit, a position sensor detecting a distorted angle of the antenna, and a first Integrated Circuit (IC) connected to the position sensor, wherein if a prescribed condition is met, the first IC calculates a correction value for correcting the distorted angle of the antenna.

The prescribed condition may be met if an angle detected through the position sensor is smaller than a threshold.

The radar module may further include a second IC processing data corresponding to a radio wave received through the radio wave receiving unit, and the first IC may deliver the calculated correction value to the second IC so as to control the second IC to correct the data.

The position sensor may include a gyroscopic sensor or an acceleration sensor.

The radar module may include a Front End Module (FEM) and a Back End Module (BEM), the antenna may be disposed on the FEM, and the position sensor and the first IC may be disposed on the BEM.

The FEM of the radar module may correspond to a Printed Circuit Board (PCB) top surface of the radar module and the BEM of the radar module may correspond to a PCB bottom surface of the radar module.

The radar module may further include a third IC for providing power to the radar module and a connector for connecting the first to third ICs.

The first IC may calculate the correction value for correcting the distorted angle of the antenna based on a ratio of a level of a radio wave received at a reference angle to a level of a radio wave received at an angle detected through the position sensor.

And, the first IC may additionally calculate the correction value for correcting the distorted angle of the antenna based on an angle corresponding to a difference between a sensor value of a gyroscopic sensor included in an Electronic Control Unit (ECU) of the vehicle and a sensor value of the position sensor.

Specific matters of other embodiments are included in the detailed description and drawings.

### Advantageous Effects

A method of aligning a radar module according to one aspect of the present invention is more advantageous than the related art alignment method in aspects of a process space, a man power, a Takt time, an error rate and a cost.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram showing an exterior of a vehicle according to an embodiment of the present invention.

FIG. 2 is a diagram showing a vehicle externally viewed in various angles according to an embodiment of the present invention.

FIG. 3 and FIG. 4 are diagrams showing an interior of a vehicle according to an embodiment of the present invention.

FIG. 5 and FIG. 6 are diagrams referred to for description of an object according to an embodiment of the present invention.

FIG. 7 is a block diagram referred to for description of a vehicle according to an embodiment of the present invention.

FIG. 8 is a diagram showing a radio wave transmitted angle of a radar.

FIG. 9 is a diagram to describe the causes of distortion in installing a radar.

FIG. 10 is a diagram to describe one alignment method of the related art.

FIG. 11 is a diagram to describe another alignment method of the related art.

FIG. 12 is a diagram to describe a radar alignment method according to the present invention.

FIG. 13 is a block diagram of a system for implementing radar alignment according to one aspect of the present invention.

FIG. 14 is a flowchart to describe radar alignment according to one aspect of the present invention.

FIG. 15 is a diagram to describe distortion correction algorithm of radar alignment according to one aspect of the present invention.

FIG. 16 is a table to compare a radar alignment process of the present invention with a related art radar alignment process.

### BEST MODE FOR INVENTION

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In the following description, with respect to constituent elements used in the following description, the suffixes “module” and “unit” are used or combined with each other only in consideration of ease in the preparation of the specification, and do not have or serve as different meanings. Accordingly, the suffixes “module” and “unit” may be interchanged with each other. In addition, in the following description of the embodiments disclosed in the present specification, a detailed description of known functions and configurations incorporated herein will be omitted when it may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents and substitutions included in the scope and sprit of the present invention.

It will be understood that although the terms “first,” “second,” etc., may be used herein to describe various components, these components should not be limited by these terms. These terms are only used to distinguish one component from another component.

It will be understood that when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless the context clearly indicates otherwise. In the present application, it will be further understood that the terms “comprises”, includes,” etc. specify the presence of stated features, integers, steps, operations, elements, components, or combinations thereof, but do not preclude the presence or addition of one or more other features, integers, steps, operations, elements, components, or combinations thereof.

A vehicle as described in this specification may include an automobile and a motorcycle. Hereinafter, a description will be given based on an automobile. A vehicle as described in this specification may include all of an internal combustion engine vehicle including an engine as a power source, a hybrid vehicle including both an engine and an electric motor as a power source, and an electric vehicle including an electric motor as a power source. In the following description, “the left side of the vehicle” refers to the left side in the forward driving direction of the vehicle, and “the right side of the vehicle” refers to the right side in the forward driving direction of the vehicle.

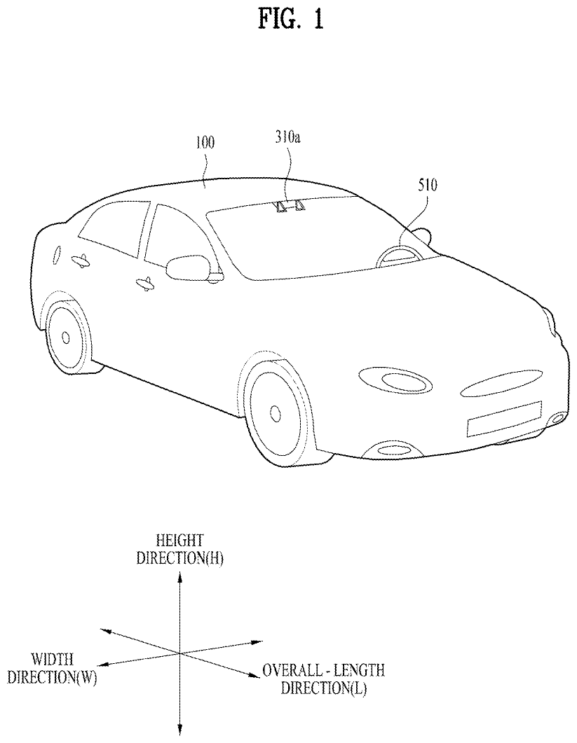

FIG. 1 is a view of the external appearance of a vehicle according to an embodiment of the present disclosure.

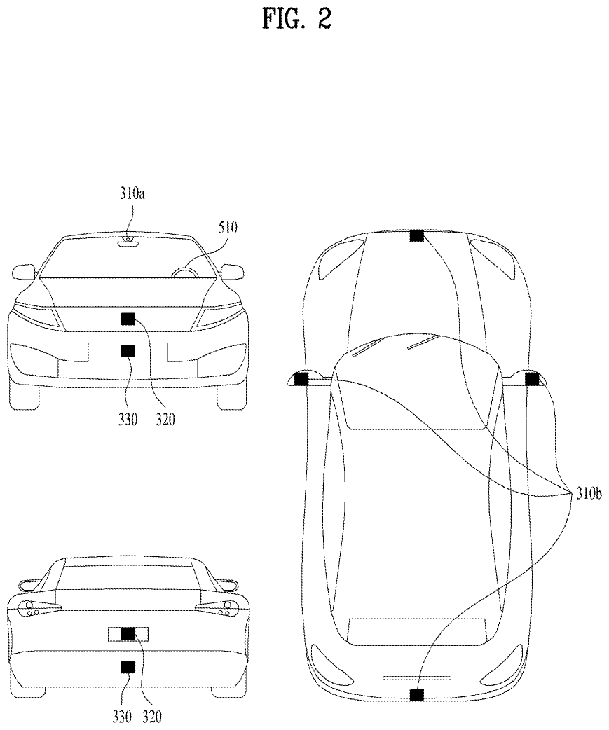

FIG. 2 is different angled views of a vehicle according to an embodiment of the present disclosure.

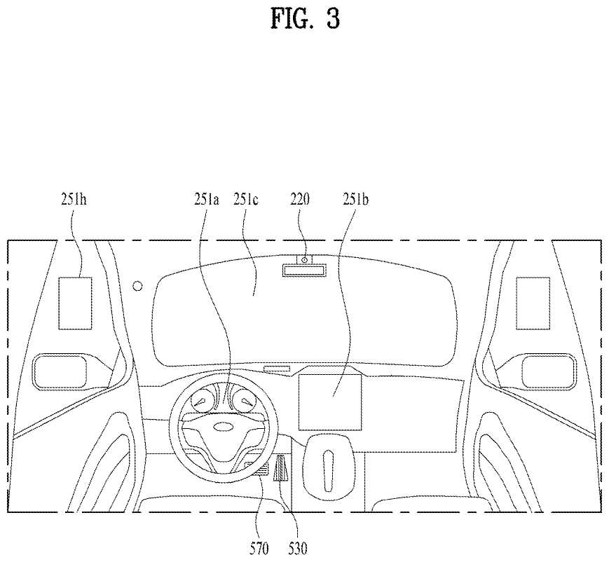

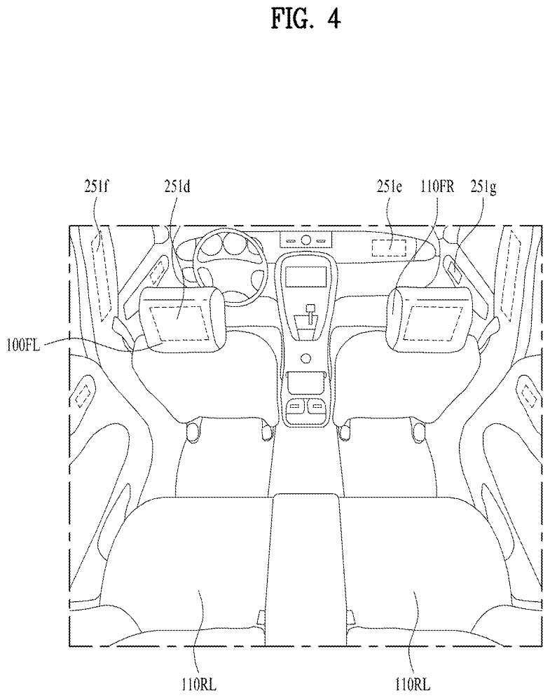

FIGS. 3 and 4 are views of the internal configuration of a vehicle according to an embodiment of the present disclosure.

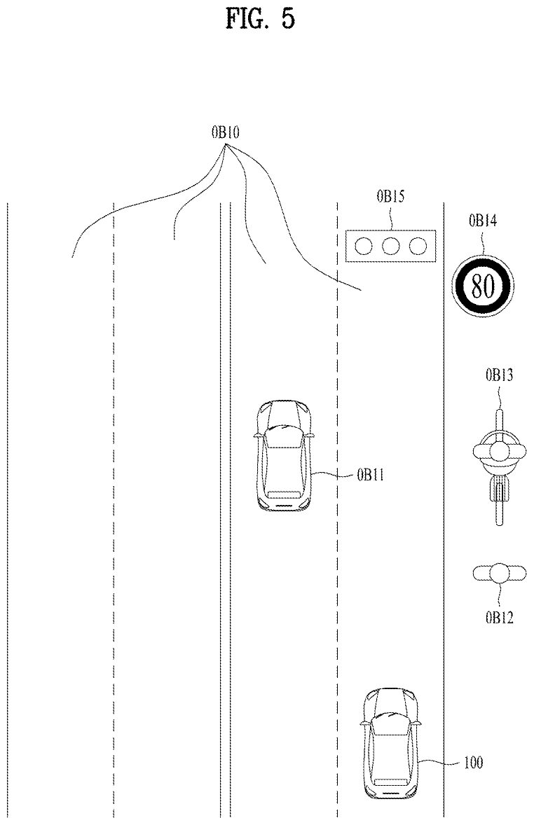

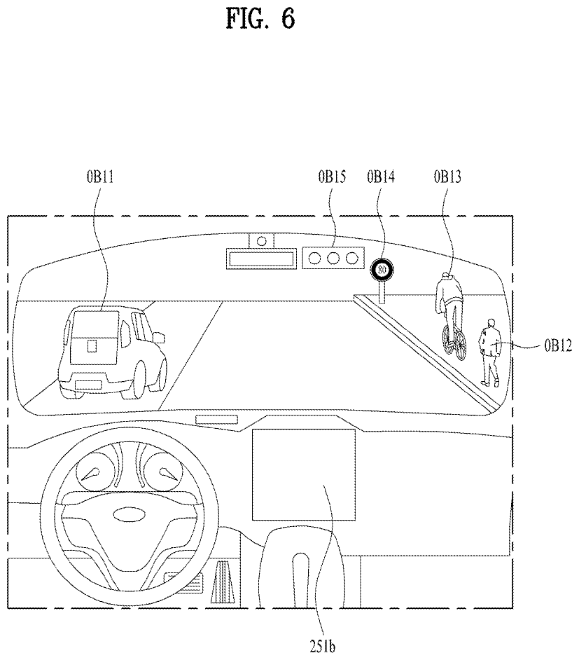

FIGS. 5 and 6 are views for explanation of objects according to an embodiment of the present disclosure.

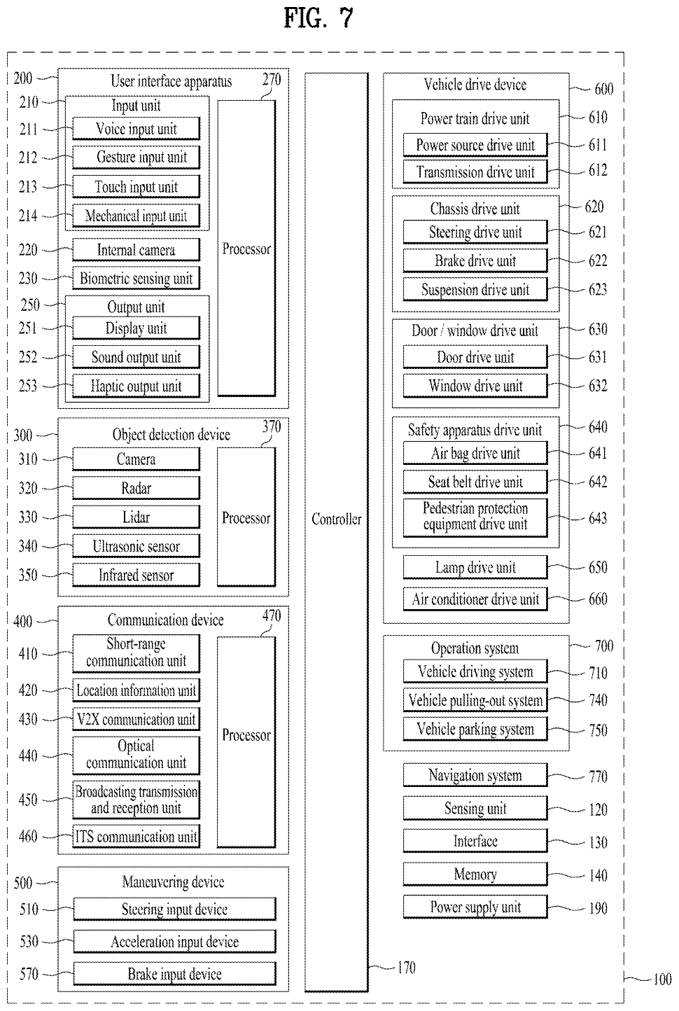

FIG. 7 is a block diagram illustrating a vehicle according to an embodiment of the present disclosure.

Referring to FIGS. 1 to 7, a vehicle 100 may include a plurality of wheels, which are rotated by a power source, and a steering input device 510 for controlling a driving direction of the vehicle 100.

The vehicle 100 may be an autonomous vehicle. The vehicle 100 may be switched to an autonomous mode or a manual mode in response to a user input. For example, in response to a user input received through a user interface apparatus 200, the vehicle 100 may be switched from a manual mode to an autonomous mode, or vice versa.

The vehicle 100 may be switched to the autonomous mode or to the manual mode based on driving environment information. The driving environment information may include at least one of the following: information on an object outside a vehicle, navigation information, and vehicle state information.

For example, the vehicle 100 may be switched from the manual mode to the autonomous mode, or vice versa, based on driving environment information generated by the object detection device 300. In another example, the vehicle 100 may be switched from the manual mode to the autonomous mode, or vice versa, based on driving environment information received through a communication device 400.

The vehicle 100 may be switched from the manual mode to the autonomous mode, or vice versa, based on information, data, and a signal provided from an external device.

When the vehicle 100 operates in the autonomous mode, the autonomous vehicle 100 may operate based on an operation system 700. For example, the autonomous vehicle 100 may operate based on information, data, or signals generated by a driving system 710, a vehicle pulling-out system 740, and a vehicle parking system 750.

While operating in the manual mode, the autonomous vehicle 100 may receive a user input for driving of the vehicle 100 through a maneuvering device 500. In response to the user input received through the maneuvering device 500, the vehicle 100 may operate.

The term “overall length” means the length from the front end to the rear end of the vehicle 100, the term “overall width” means the width of the vehicle 100, and the term “overall height” means the height from the bottom of the wheel to the roof. In the following description, the term “overall length direction L” may mean the reference direction for the measurement of the overall length of the vehicle 100, the term “overall width direction W” may mean the reference direction for the measurement of the overall width of the vehicle 100, and the term “overall height direction H” may mean the reference direction for the measurement of the overall height of the vehicle 100.

As illustrated in FIG. 7, the vehicle 100 may include the user interface device 200, the object detection device 300, the communication device 400, the maneuvering device 500, a vehicle drive device 600, the operation system 700, a navigation system 770, a sensing unit 120, an interface 130, a memory 140, a controller 170, and a power supply unit 190.

In some embodiments, the vehicle 100 may further include other components in addition to the aforementioned components, or may not include some of the aforementioned components. The sensing unit 120 may sense the state of the vehicle. The sensing unit 120 may include an attitude sensor (for example, a yaw sensor, a roll sensor, or a pitch sensor), a collision sensor, a wheel sensor, a speed sensor, a gradient sensor, a weight sensor, a heading sensor, a gyro sensor, a position module, a vehicle forward/reverse movement sensor, a battery sensor, a fuel sensor, a tire sensor, a steering sensor based on the rotation of the steering wheel, an in-vehicle temperature sensor, an in-vehicle humidity sensor, an ultrasonic sensor, an illumination sensor, an accelerator pedal position sensor, and a brake pedal position sensor.

The sensing unit 120 may acquire sensing signals with regard to, for example, vehicle attitude information, vehicle collision information, vehicle driving direction information, vehicle location information (GPS information), vehicle angle information, vehicle speed information, vehicle acceleration information, vehicle tilt information, vehicle forward/reverse movement information, battery information, fuel information, tire information, vehicle lamp information, in-vehicle temperature information, in-vehicle humidity information, steering-wheel rotation angle information, outside illumination information, information about the pressure applied to an accelerator pedal, and information about the pressure applied to a brake pedal.

The sensing unit 120 may further include, for example, an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, and a Crank Angle Sensor (CAS).

The sensing unit 120 may generate vehicle state information based on sensing data. The vehicle condition information may be information that is generated based on data sensed by a variety of sensors inside a vehicle.

For example, the vehicle state information may include vehicle position information, vehicle speed information, vehicle tilt information, vehicle weight information, vehicle direction information, vehicle battery information, vehicle fuel information, vehicle tire pressure information, vehicle steering information, in-vehicle temperature information, in-vehicle humidity information, pedal position information, vehicle engine temperature information, etc.

The interface 130 may serve as a passage for various kinds of external devices that are connected to the vehicle 100. For example, the interface 130 may have a port that is connectable to a mobile terminal and may be connected to the mobile terminal via the port. In this case, the interface 130 may exchange data with the mobile terminal.

Meanwhile, the interface 130 may serve as a passage for the supply of electrical energy to a mobile terminal connected thereto. When the mobile terminal is electrically connected to the interface 130, the interface 130 may provide electrical energy, supplied from the power supply unit 190, to the mobile terminal under control of the controller 170.

The memory 140 is electrically connected to the controller 170. The memory 140 may store basic data for each unit, control data for the operational control of each unit, and input/output data. The memory 140 may be any of various hardware storage devices, such as a ROM, a RAM, an EPROM, a flash drive, and a hard drive. The memory 140 may store various data for the overall operation of the vehicle 100, such as programs for the processing or control of the controller 170. In some embodiments, the memory 140 may be integrally formed with the controller 170, or may be provided as an element of the controller 170.

The controller 170 may control the overall operation of each unit inside the vehicle 100. The controller 170 may be referred to as an Electronic Controller (ECU). The power supply unit 190 may supply power required to operate each component under control of the controller 170. In particular, the power supply unit 190 may receive power from, for example, a battery inside the vehicle 100.

At least one processor and the controller 170 included in the vehicle 100 may be implemented using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electric units for the implementation of other functions.

Moreover, the sensing unit 120, the interface unit 130, the memory 140, the power supply unit 190, the user interface device 200, the object detection device 300, the communication device 400, the maneuvering device 500, the vehicle drive device 600, the operation system 700 and the navigation system 770 may have individual processors or be integrated into the controller 170.

The user interface device 200 is provided to support communication between the vehicle 100 and a user. The user interface device 200 may receive a user input, and provide information generated in the vehicle 100 to the user. The vehicle 100 may enable User Interfaces (UI) or User Experience (UX) through the user interface device 200.

The user interface device 200 may include an input unit 210, an internal camera 220, a biometric sensing unit 230, an output unit 250, and a processor 270. Each component of the user interface device 200 may be separated from or integrated with the afore-described interface 130, structurally or operatively.

In some embodiments, the user interface device 200 may further include other components in addition to the aforementioned components, or may not include some of the aforementioned components.

The input unit 210 is configured to receive information from a user, and data collected in the input unit 210 may be analyzed by the processor 270 and then processed into a control command of the user.

The input unit 210 may be disposed inside the vehicle 100. For example, the input unit 210 may be disposed in a region of a steering wheel, a region of an instrument panel, a region of a seat, a region of each pillar, a region of a door, a region of a center console, a region of a head lining, a region of a sun visor, a region of a windshield, or a region of a window.

The input unit 210 may include a voice input unit 211, a gesture input unit 212, a touch input unit 213, and a mechanical input unit 214.

The voice input unit 211 may convert a voice input of a user into an electrical signal. The converted electrical signal may be provided to the processor 270 or the controller 170. The voice input unit 211 may include one or more microphones.

The gesture input unit 212 may convert a gesture input of a user into an electrical signal. The converted electrical signal may be provided to the processor 270 or the controller 170. The gesture input unit 212 may include at least one selected from among an infrared sensor and an image sensor for sensing a gesture input of a user.

In some embodiments, the gesture input unit 212 may sense a three-dimensional (3D) gesture input of a user. To this end, the gesture input unit 212 may include a plurality of light emitting units for outputting infrared light, or a plurality of image sensors. The gesture input unit 212 may sense the 3D gesture input by employing a Time of Flight (TOF) scheme, a structured light scheme, or a disparity scheme.

The touch input unit 213 may convert a user's touch input into an electrical signal. The converted electrical signal may be provided to the processor 270 or the controller 170. The touch input unit 213 may include a touch sensor for sensing a touch input of a user. In some embodiments, the touch input unit 210 may be formed integral with a display unit 251 to implement a touch screen. The touch screen may provide an input interface and an output interface between the vehicle 100 and the user.

The mechanical input unit 214 may include at least one selected from among a button, a dome switch, a jog wheel, and a jog switch. An electrical signal generated by the mechanical input unit 214 may be provided to the processor 270 or the controller 170. The mechanical input unit 214 may be located on a steering wheel, a center fascia, a center console, a cockpit module, a door, etc.

The processor 270 may start a learning mode of the vehicle 100 in response to a user input to at least one of the afore-described voice input unit 211, gesture input unit 212, touch input unit 213, or mechanical input unit 214. In the learning mode, the vehicle 100 may learn a driving route and ambient environment of the vehicle 100. The learning mode will be described later in detail in relation to the object detection device 300 and the operation system 700.

The internal camera 220 may acquire images of the inside of the vehicle 100. The processor 270 may sense a user's condition based on the images of the inside of the vehicle 100. The processor 270 may acquire information on an eye gaze of the user. The processor 270 may sense a gesture of the user from the images of the inside of the vehicle 100.

The biometric sensing unit 230 may acquire biometric information of the user. The biometric sensing unit 230 may include a sensor for acquire biometric information of the user, and may utilize the sensor to acquire finger print information, heart rate information, etc. of the user. The biometric information may be used for user authentication.

The output unit 250 is configured to generate a visual, audio, or tactile output. The output unit 250 may include at least one selected from among a display unit 251, a sound output unit 252, and a haptic output unit 253.

The display unit 251 may display graphic objects corresponding to various types of information. The display unit 251 may include at least one selected from among a Liquid Crystal Display (LCD), a Thin Film Transistor-Liquid Crystal Display (TFT LCD), an Organic Light-Emitting Diode (OLED), a flexible display, a 3D display, and an e-ink display.

The display unit 251 may form an inter-layer structure together with the touch input unit 213, or may be integrally formed with the touch input unit 213 to implement a touch screen. The display unit 251 may be implemented as a Head Up Display (HUD). When implemented as a HUD, the display unit 251 may include a projector module in order to output information through an image projected on a windshield or a window. The display unit 251 may include a transparent display. The transparent display may be attached on the windshield or the window.

The transparent display may display a predetermined screen with a predetermined transparency. In order to achieve the transparency, the transparent display may include at least one selected from among a transparent Thin Film Electroluminescent (TFEL) display, an Organic Light Emitting Diode (OLED) display, a transparent Liquid Crystal Display (LCD), a transmissive transparent display, and a transparent Light Emitting Diode (LED) display. The transparency of the transparent display may be adjustable.

Meanwhile, the user interface device 200 may include a plurality of display units 251a to 251g.

The display unit 251 may be disposed in a region of a steering wheel, a region 251a, 251b or 251e of an instrument panel, a region 251d of a seat, a region 251f of each pillar, a region 251g of a door, a region of a center console, a region of a head lining, a region of a sun visor, a region 251c of a windshield, or a region 251h of a window.

The sound output unit 252 converts an electrical signal from the processor 270 or the controller 170 into an audio signal, and outputs the audio signal. To this end, the sound output unit 252 may include one or more speakers.

The haptic output unit 253 generates a tactile output. For example, the haptic output unit 253 may operate to vibrate a steering wheel, a safety belt, and seats 110FL, 110FR, 110RL, and 110RR so as to allow a user to recognize the output.

The processor 270 may control the overall operation of each unit of the user interface device 200. In some embodiments, the user interface device 200 may include a plurality of processors 270 or may not include the processor 270.

In a case where the user interface device 200 does not include the processor 270, the user interface device 200 may operate under control of the controller 170 or a processor of a different device inside the vehicle 100. Meanwhile, the user interface device 200 may be referred to as a display device for vehicle. The user interface device 200 may operate under control of the controller 170.

The object detection device 300 is used to detect an object outside the vehicle 100. The object detection device 300 may generate object information based on sensing data.

The object information may include information about the presence of an object, location information of the object, information on distance between the vehicle and the object, and the speed of the object relative to the vehicle 100. The object may include various objects related to travelling of the vehicle 100.

Referring to FIGS. 5 and 6, an object o may include a lane OB10, a nearby vehicle OB11, a pedestrian OB12, a two-wheeled vehicle OB13, a traffic signal OB14 and OB15, a light, a road, a structure, a bump, a geographical feature, an animal, etc.

The lane OB10 may be a lane in which the vehicle 100 is traveling (hereinafter, referred to as the current driving lane), a lane next to the current driving lane, and a lane in which a vehicle travelling in the opposite direction is travelling. The lane OB10 may include left and right lines that define the lane.

The nearby vehicle OB11 may be a vehicle that is travelling in the vicinity of the vehicle 100. The nearby vehicle OB11 may be a vehicle within a predetermined distance from the vehicle 100. For example, the nearby vehicle OB11 may be a vehicle that is preceding or following the vehicle 100.

The pedestrian OB12 may be a person in the vicinity of the vehicle 100. The pedestrian OB12 may be a person within a predetermined distance from the vehicle 100. For example, the pedestrian OB12 may be a person on a sidewalk or on the roadway.

The two-wheeled vehicle OB13 is a vehicle that is located in the vicinity of the vehicle 100 and moves with two wheels. The two-wheeled vehicle OB13 may be a vehicle that has two wheels within a predetermined distance from the vehicle 100. For example, the two-wheeled vehicle OB13 may be a motorcycle or a bike on a sidewalk or the roadway.

The traffic signal may include a traffic light OB15, a traffic sign plate OB14, and a pattern or text painted on a road surface. The light may be light generated by a lamp provided in the nearby vehicle. The light may be light generated by a street light. The light may be solar light. The road may include a road surface, a curve, and slopes, such as an upward slope and a downward slope. The structure may be a body located around the road in the state of being fixed onto the ground. For example, the structure may include a streetlight, a roadside tree, a building, a traffic light, and a bridge. The geographical feature may include a mountain and a hill.

Meanwhile, the object may be classified as a movable object or a stationary object. For example, the movable object may include a nearby vehicle and a pedestrian. For example, the stationary object may include a traffic signal, a road, and a structure.

The object detection device 300 may include a camera 310, a radar 320, a lidar 330, an ultrasonic sensor 340, an infrared sensor 350, and a processor 370. Each component of the object detection device 300 may be separated from or integrated with the sensing unit 120, structurally or operatively.

In some embodiments, the object detection device 300 may further include other components in addition to the aforementioned components, or may not include some of the aforementioned components.

The camera 310 may be located at an appropriate position outside the vehicle 100 in order to acquire images of the outside of the vehicle 100. The camera 310 may be a mono camera, a stereo camera 310a, an Around View Monitoring (AVM) camera 310b, or a 360-degree camera.

Using various image processing algorithms, the camera 310 may acquire location information of an object, information on distance to the object, and information on speed relative to the object.

For example, based on change in size over time of an object in acquired images, the camera 310 may acquire information on distance to the object and information on speed relative to the object.

For example, the camera 310 may acquire the information on distance to the object and the information on speed relative to the object by utilizing a pin hole model or by profiling a road surface.

For example, the camera 310 may acquire the information on distance to the object and the information on the speed relative to the object, based on information on disparity of stereo images acquired by a stereo camera 310a.

For example, the camera 310 may be disposed near a front windshield in the vehicle 100 in order to acquire images of the front of the vehicle 100. Alternatively, the camera 310 may be disposed around a front bumper or a radiator grill.

In another example, the camera 310 may be disposed near a rear glass in the vehicle 100 in order to acquire images of the rear of the vehicle 100. Alternatively, the camera 310 may be disposed around a rear bumper, a trunk, or a tailgate.

In yet another example, the camera 310 may be disposed near at least one of the side windows in the vehicle 100 in order to acquire images of the side of the vehicle 100. Alternatively, the camera 310 may be disposed around a side mirror, a fender, or a door.

The camera 310 may provide an acquired image to the processor 370.

The radar 320 may include an electromagnetic wave transmission unit and an electromagnetic wave reception unit. The radar 320 may be realized as a pulse radar or a continuous wave radar depending on the principle of emission of an electronic wave. In addition, the radar 320 may be realized as a Frequency Modulated Continuous Wave (FMCW) type radar or a Frequency Shift Keying (FSK) type radar depending on the waveform of a signal.

The radar 320 may detect an object through the medium of an electromagnetic wave by employing a time of flight (TOF) scheme or a phase-shift scheme, and may detect a location of the detected object, the distance to the detected object, and the speed relative to the detected object.

The radar 320 may be located at an appropriate position outside the vehicle 100 in order to sense an object located in front of the vehicle 100, an object located to the rear of the vehicle 100, or an object located to the side of the vehicle 100.

The lidar 330 may include a laser transmission unit and a laser reception unit. The lidar 330 may be implemented by the TOF scheme or the phase-shift scheme.

The lidar 330 may be implemented as a drive type lidar or a non-drive type lidar. When implemented as the drive type lidar, the lidar 300 may rotate by a motor and detect an object in the vicinity of the vehicle 100. When implemented as the non-drive type lidar, the lidar 300 may utilize a light steering technique to detect an object located within a predetermined distance from the vehicle 100.

The lidar 330 may detect an object through the medium of laser light by employing the TOF scheme or the phase-shift scheme, and may detect a location of the detected object, the distance to the detected object, and the speed relative to the detected object. The lidar 330 may be located at an appropriate position outside the vehicle 100 in order to sense an object located in front of the vehicle 100, an object located to the rear of the vehicle 100, or an object located to the side of the vehicle 100.

The ultrasonic sensor 340 may include an ultrasonic wave transmission unit and an ultrasonic wave reception unit. The ultrasonic sensor 340 may detect an object based on an ultrasonic wave, and may detect a location of the detected object, the distance to the detected object, and the speed relative to the detected object. The ultrasonic sensor 340 may be located at an appropriate position outside the vehicle 100 in order to detect an object located in front of the vehicle 100, an object located to the rear of the vehicle 100, and an object located to the side of the vehicle 100.

The infrared sensor 350 may include an infrared light transmission unit and an infrared light reception unit. The infrared sensor 340 may detect an object based on infrared light, and may detect a location of the detected object, the distance to the detected object, and the speed relative to the detected object. The infrared sensor 350 may be located at an appropriate position outside the vehicle 100 in order to sense an object located in front of the vehicle 100, an object located to the rear of the vehicle 100, or an object located to the side of the vehicle 100.

The processor 370 may control the overall operation of each unit of the object detection device 300. The processor 370 may detect or classify an object by comparing data sensed by the camera 310, the radar 320, the lidar 330, the ultrasonic sensor 340, and the infrared sensor 350 with pre-stored data.

The processor 370 may detect and track an object based on acquired images. The processor 370 may, for example, calculate the distance to the object and the speed relative to the object.

For example, the processor 370 may acquire information on the distance to the object and information on the speed relative to the object based on a variation in size over time of the object in acquired images.

In another example, the processor 370 may acquire information on the distance to the object or information on the speed relative to the object by employing a pin hole model or by profiling a road surface.

In yet another example, the processor 370 may acquire information on the distance to the object and information on the speed relative to the object based on information on disparity of stereo images acquired from the stereo camera 310a.

The processor 370 may detect and track an object based on a reflection electromagnetic wave which is formed as a result of reflection a transmission electromagnetic wave by the object. Based on the electromagnetic wave, the processor 370 may, for example, calculate the distance to the object and the speed relative to the object.

The processor 370 may detect and track an object based on a reflection laser light which is formed as a result of reflection of transmission laser by the object. Based on the laser light, the processor 370 may, for example, calculate the distance to the object and the speed relative to the object.

The processor 370 may detect and track an object based on a reflection ultrasonic wave which is formed as a result of reflection of a transmission ultrasonic wave by the object. Based on the ultrasonic wave, the processor 370 may, for example, calculate the distance to the object and the speed relative to the object.

The processor 370 may detect and track an object based on reflection infrared light which is formed as a result of reflection of transmission infrared light by the object. Based on the infrared light, the processor 370 may, for example, calculate the distance to the object and the speed relative to the object.

As described before, once the vehicle 100 starts the learning mode in response to a user input to the input unit 210, the processor 370 may store data sensed by the camera 310, the radar 320, the lidar 330, the ultrasonic sensor 340, and the infrared sensor 350 in the memory 140.

Each step of the learning mode based on analysis of stored data, and an operating mode following the learning mode will be described later in detail in relation to the operation system 700. According to an embodiment, the object detection device 300 may include a plurality of processors 370 or no processor 370. For example, the camera 310, the radar 320, the lidar 330, the ultrasonic sensor 340, and the infrared sensor 350 may include individual processors.

In a case where the object detection device 300 does not include the processor 370, the object detection device 300 may operate under control of the controller 170 or a processor inside the vehicle 100. The object detection device 300 may operate under control of the controller 170.

The communication device 400 is configured to perform communication with an external device. Here, the external device may be a nearby vehicle, a mobile terminal, or a server. To perform communication, the communication device 400 may include at least one selected from among a transmission antenna, a reception antenna, a Radio Frequency (RF) circuit capable of implementing various communication protocols, and an RF device.

The communication device 400 may include a short-range communication unit 410, a location information unit 420, a V2X communication unit 430, an optical communication unit 440, a broadcast transmission and reception unit 450, an Intelligent Transport Systems (ITS) communication unit 460, and a processor 470. In some embodiments, the communication device 400 may further include other components in addition to the aforementioned components, or may not include some of the aforementioned components.

The short-range communication unit 410 is configured to perform short-range communication. The short-range communication unit 410 may support short-range communication using at least one selected from among Bluetooth™, Radio Frequency IDdentification (RFID), Infrared Data Association (IrDA), Ultra-WideBand (UWB), ZigBee, Near Field Communication (NFC), Wireless-Fidelity (Wi-Fi), Wi-Fi Direct, and Wireless USB (Wireless Universal Serial Bus). The short-range communication unit 410 may form wireless area networks to perform short-range communication between the vehicle 100 and at least one external device.

The location information unit 420 is configured to acquire location information of the vehicle 100. For example, the location information unit 420 may include a Global Positioning System (GPS) module or a Differential Global Positioning System (DGPS) module.

The V2X communication unit 430 is configured to perform wireless communication between a vehicle and a server (that is, vehicle to infra (V2I) communication), wireless communication between a vehicle and a nearby vehicle (that is, vehicle to vehicle (V2V) communication), or wireless communication between a vehicle and a pedestrian (that is, vehicle to pedestrian (V2P) communication).

The optical communication unit 440 is configured to perform communication with an external device through the medium of light. The optical communication unit 440 may include a light emitting unit, which converts an electrical signal into an optical signal and transmits the optical signal to the outside, and a light receiving unit which converts a received optical signal into an electrical signal. In some embodiments, the light emitting unit may be integrally formed with a lamp provided included in the vehicle 100.

The broadcast transmission and reception unit 450 is configured to receive a broadcast signal from an external broadcasting management server or transmit a broadcast signal to the broadcasting management server through a broadcasting channel. The broadcasting channel may include a satellite channel, and a terrestrial channel. The broadcast signal may include a TV broadcast signal, a radio broadcast signal, and a data broadcast signal.

The ITS communication unit 460 may exchange information, data, or signals with a traffic system. The ITS communication unit 460 may provide acquired information or data to the traffic system. The ITS communication unit 460 may receive information, data, or signals from the traffic system. For example, the ITS communication unit 460 may receive traffic information from the traffic system and provide the traffic information to the controller 170. In another example, the ITS communication unit 460 may receive a control signal from the traffic system, and provide the control signal to the controller 170 or a processor provided in the vehicle 100.

The processor 470 may control the overall operation of each unit of the communication device 400. In some embodiments, the communication device 400 may include a plurality of processors 470, or may not include the processor 470. In a case where the communication device 400 does not include the processor 470, the communication device 400 may operate under control of the controller 170 or a processor of a device inside of the vehicle 100.

Meanwhile, the communication device 400 may implement a vehicle display device, together with the user interface device 200. In this case, the vehicle display device may be referred to as a telematics device or an Audio Video Navigation (AVN) device. The communication device 400 may operate under control of the controller 170.

The maneuvering device 500 is configured to receive a user input for driving the vehicle 100. In the manual mode, the vehicle 100 may operate based on a signal provided by the maneuvering device 500. The maneuvering device 500 may include a steering input device 510, an acceleration input device 530, and a brake input device 570.

The steering input device 510 may receive a user input with regard to the direction of travel of the vehicle 100. The steering input device 510 may take the form of a wheel to enable a steering input through the rotation thereof. In some embodiments, the steering input device may be provided as a touchscreen, a touch pad, or a button.

The acceleration input device 530 may receive a user input for acceleration of the vehicle 100. The brake input device 570 may receive a user input for deceleration of the vehicle 100. Each of the acceleration input device 530 and the brake input device 570 may take the form of a pedal. In some embodiments, the acceleration input device or the break input device may be configured as a touch screen, a touch pad, or a button.

The maneuvering device 500 may operate under control of the controller 170.

The vehicle drive device 600 is configured to electrically control the operation of various devices of the vehicle 100. The vehicle drive device 600 may include a power train drive unit 610, a chassis drive unit 620, a door/window drive unit 630, a safety apparatus drive unit 640, a lamp drive unit 650, and an air conditioner drive unit 660. In some embodiments, the vehicle drive device 600 may further include other components in addition to the aforementioned components, or may not include some of the aforementioned components. Meanwhile, the vehicle drive device 600 may include a processor. Each unit of the vehicle drive device 600 may include its own processor.

The power train drive unit 610 may control the operation of a power train. The power train drive unit 610 may include a power source drive unit 611 and a transmission drive unit 612.

The power source drive unit 611 may control a power source of the vehicle 100. In the case in which a fossil fuel-based engine is the power source, the power source drive unit 611 may perform electronic control of the engine. As such the power source drive unit 611 may control, for example, the output torque of the engine. The power source drive unit 611 may adjust the output toque of the engine under control of the controller 170.

In a case where an electric motor is the power source, the power source drive unit 611 may control the motor. The power source drive unit 610 may control, for example, the RPM and toque of the motor under control of the controller 170.

The transmission drive unit 612 may control a transmission. The transmission drive unit 612 may adjust the state of the transmission. The transmission drive unit 612 may adjust a state of the transmission to a drive (D), reverse (R), neutral (N), or park (P) state. Meanwhile, in a case where an engine is the power source, the transmission drive unit 612 may adjust a gear-engaged state to the drive position D.

The chassis drive unit 620 may control the operation of a chassis. The chassis drive unit 620 may include a steering drive unit 621, a brake drive unit 622, and a suspension drive unit 623.

The steering drive unit 621 may perform electronic control of a steering apparatus provided inside the vehicle 100. The steering drive unit 621 may change the direction of travel of the vehicle 100.

The brake drive unit 622 may perform electronic control of a brake apparatus provided inside the vehicle 100. For example, the brake drive unit 622 may reduce the speed of the vehicle 100 by controlling the operation of a brake located at a wheel.

Meanwhile, the brake drive unit 622 may control a plurality of brakes individually. The brake drive unit 622 may apply a different degree-braking force to each wheel.

The suspension drive unit 623 may perform electronic control of a suspension apparatus inside the vehicle 100. For example, when the road surface is uneven, the suspension drive unit 623 may control the suspension apparatus so as to reduce the vibration of the vehicle 100. Meanwhile, the suspension drive unit 623 may control a plurality of suspensions individually.

The door/window drive unit 630 may perform electronic control of a door apparatus or a window apparatus inside the vehicle 100. The door/window drive unit 630 may include a door drive unit 631 and a window drive unit 632.

The door drive unit 631 may control the door apparatus. The door drive unit 631 may control opening or closing of a plurality of doors included in the vehicle 100. The door drive unit 631 may control opening or closing of a trunk or a tail gate. The door drive unit 631 may control opening or closing of a sunroof.

The window drive unit 632 may perform electronic control of the window apparatus. The window drive unit 632 may control opening or closing of a plurality of windows included in the vehicle 100.

The safety apparatus drive unit 640 may perform electronic control of various safety apparatuses provided inside the vehicle 100. The safety apparatus drive unit 640 may include an airbag drive unit 641, a safety belt drive unit 642, and a pedestrian protection equipment drive unit 643.

The airbag drive unit 641 may perform electronic control of an airbag apparatus inside the vehicle 100. For example, upon detection of a dangerous situation, the airbag drive unit 641 may control an airbag to be deployed.

The safety belt drive unit 642 may perform electronic control of a seatbelt apparatus inside the vehicle 100. For example, upon detection of a dangerous situation, the safety belt drive unit 642 may control passengers to be fixed onto seats 110FL, 110FR, 110RL, and 110RR with safety belts.

The pedestrian protection equipment drive unit 643 may perform electronic control of a hood lift and a pedestrian airbag. For example, upon detection of a collision with a pedestrian, the pedestrian protection equipment drive unit 643 may control a hood lift and a pedestrian airbag to be deployed.

The lamp drive unit 650 may perform electronic control of various lamp apparatuses provided inside the vehicle 100.

The air conditioner drive unit 660 may perform electronic control of an air conditioner inside the vehicle 100. For example, when the inner temperature of the vehicle 100 is high, an air conditioner drive unit 660 may operate the air conditioner so as to supply cool air to the inside of the vehicle 100.

The vehicle drive device 600 may include a processor. Each unit of the vehicle dive device 600 may include its own processor. The vehicle drive device 600 may operate under control of the controller 170.

The operation system 700 is a system for controlling the overall driving operation of the vehicle 100. The operation system 700 may operate in the autonomous driving mode.

The operation system 700 may include the driving system 710, the vehicle pulling-out system 740, and the vehicle parking system 750. In some embodiments, the operation system 700 may further include other components in addition to the aforementioned components, or may not include some of the aforementioned component. Meanwhile, the operation system 700 may include a processor. Each unit of the operation system 700 may include its own processor.

Meanwhile, the operation system 700 may control driving in the autonomous mode based on learning. In this case, the learning mode and an operating mode based on the premise of completion of learning may be performed. A description will be given below of a method of executing the learning mode and the operating mode by the processor of the operation system 700.

The learning mode may be performed in the afore-described manual mode. In the learning mode, the processor of the operation system 700 may learn a driving route and ambient environment of the vehicle 100.

The learning of the driving route may include generating map data for a route in which the vehicle 100 drives. Particularly, the processor of the operation system 700 may generate map data based on information detected through the object detection device 300 during driving from a departure to a destination.

The learning of the ambient environment may include storing and analyzing information about an ambient environment of the vehicle 100 during driving and parking. Particularly, the processor of the operation system 700 may store and analyze the information about the ambient environment of the vehicle based on information detected through the object detection device 300 during parking of the vehicle 100, for example, information about a location, size, and a fixed (or mobile) obstacle of a parking space.

The operating mode may be performed in the afore-described autonomous mode. The operating mode will be described based on the premise that the driving route or the ambient environment has been learned in the learning mode.

The operating mode may be performed in response to a user input through the input unit 210, or when the vehicle 100 reaches the learned driving route and parking space, the operating mode may be performed automatically.

The operating mode may include a semi-autonomous operating mode requiring some user's manipulations of the maneuvering device 500, and a full autonomous operating mode requiring no user's manipulation of the maneuvering device 500.

According to an embodiment, the processor of the operation system 700 may drive the vehicle 100 along the learned driving route by controlling the operation system 710 in the operating mode.

According to an embodiment, the processor of the operation system 700 may pull out the vehicle 100 from the learned parking space by controlling the vehicle pulling-out system 740 in the operating mode.

According to an embodiment, the processor of the operation system 700 may park the vehicle 100 in the learned parking space by controlling the vehicle parking system 750 in the operating mode. Meanwhile, in some embodiments, in a case where the operation system 700 is implemented as software, the operation system 700 may be a subordinate concept of the controller 170.

Meanwhile, in some embodiments, the operation system 700 may be a concept including at least one selected from among the user interface device 200, the object detection device 300, the communication device 400, the vehicle drive device 600, and the controller 170.

The driving system 710 may perform driving of the vehicle 100. The driving system 710 may perform driving of the vehicle 100 by providing a control signal to the vehicle drive device 600 in response to reception of navigation information from the navigation system 770.

The driving system 710 may perform driving of the vehicle 100 by providing a control signal to the vehicle drive device 600 in response to reception of object information from the object detection device 300. The driving system 710 may perform driving of the vehicle 100 by providing a control signal to the vehicle drive device 600 in response to reception of a signal from an external device through the communication device 400.

Conceptually, the driving system 710 may be a system that drives the vehicle 100, including at least one of the user interface device 200, the object detection device 300, the communication device 400, the maneuvering device 500, the vehicle drive device 600, the navigation system 770, the sensing unit 120, or the controller 170. The driving system 710 may be referred to as a vehicle driving control device.

The vehicle pulling-out system 740 may perform an operation of pulling the vehicle 100 out of a parking space. The vehicle pulling-out system 740 may perform an operation of pulling the vehicle 100 out of a parking space, by providing a control signal to the vehicle drive device 600 in response to reception of navigation information from the navigation system 770.

The vehicle pulling-out system 740 may perform an operation of pulling the vehicle 100 out of a parking space, by providing a control signal to the vehicle drive device 600 in response to reception of object information from the object detection device 300.

The vehicle pulling-out system 740 may perform an operation of pulling the vehicle 100 out of a parking space, by providing a control signal to the vehicle drive device 600 in response to reception of a signal from an external device.

Conceptually, the vehicle pulling-out system 740 may be a system that performs pulling-out of the vehicle 100, including at least one of the user interface device 200, the object detection device 300, the communication device 400, the maneuvering device 500, the vehicle drive device 600, the navigation system 770, the sensing unit 120, or the controller 170.

The vehicle pulling-out system 740 may be referred to as a vehicle pulling-out control device.

The vehicle parking system 750 may perform an operation of parking the vehicle 100 in a parking space. The vehicle parking system 750 may perform an operation of parking the vehicle 100 in a parking space, by providing a control signal to the vehicle drive device 600 in response to reception of navigation information from the navigation system 770.

The vehicle parking system 750 may perform an operation of parking the vehicle 100 in a parking space, by providing a control signal to the vehicle drive device 600 in response to reception of object information from the object detection device 300.

The vehicle parking system 750 may perform an operation of parking the vehicle 100 in a parking space, by providing a control signal to the vehicle drive device 600 in response to reception of a signal from an external device.

Conceptually, the vehicle parking system 750 may be a system that performs parking of the vehicle 100, including at least one of the user interface device 200, the object detection device 300, the communication device 400, the maneuvering device 500, the vehicle drive device 600, the navigation system 770, the sensing unit 120, or the controller 170.

The vehicle parking system 750 may be referred to as a vehicle parking control device.

The navigation system 770 may provide navigation information. The navigation information may include at least one selected from among map information, information on a set destination, information on a route to the set destination, information on various objects along the route, lane information, and information on a current location of the vehicle.

The navigation system 770 may include a memory and a processor. The memory may store navigation information. The processor may control the operation of the navigation system 770.

In some embodiments, the navigation system 770 may update pre-stored information by receiving information from an external device through the communication device 400. In some embodiments, the navigation system 770 may be classified as an element of the user interface device 200.

[Radar Overview]

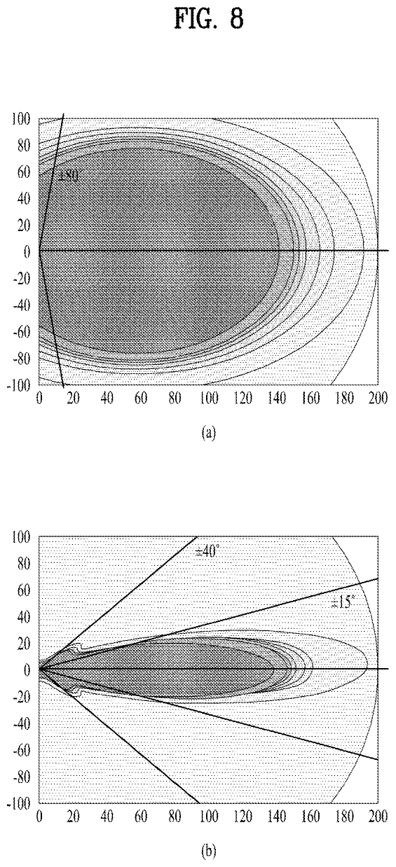

FIG. 8 is a diagram showing a radio wave transmitted angle of a radar. Particularly, FIG. 8 (a) shows an azimuth beam pattern and FIG. 8 (b) shows an elevation beam pattern.

As described above, the radar 320 can detect an object through a radio wave transmitting unit and a radio wave receiving unit and also detect a location of the detected object, a distance from the detected object and a relative velocity relative to the detected object.

The radar can be categorized into Long Range Radar (LRR), Middle Range Radar (MRR), or Short Range Radar (SRR) according to a propagation distance. A radar of a vehicle can be radiated up to 200 m at the angles of ±80° from the perspective of the azimuth beam pattern shown in FIG. 8 (a) or radiated up to 200 m at the angles of ±40° and ±15° from the perspective of the elevation beam pattern shown in FIG. 8 (b).

Meanwhile, a radar hardly misses a target for an elevation direction in a TX output beam pattern. Namely, it is possible to measure a target within about ±15° (at 70 m) or about ±40° (at 25 m) in the elevation direction.

Meanwhile, a mass-producing process for installing a radar including a radio wave transmitting unit and a radio wave receiving unit at a vehicle includes an alignment process for measuring and correcting distortion of a radar in comparison with a reference. This is because the radar may not be normally installed at the vehicle due to various causes such as: i) distortion of a vehicle frame; and ii) distortion of Printed Circuit Board (PCB) in the radar.

Described in the following are causes of distortion on installing a radar, an alignment method of the related art and an alignment method proposed by the present invention.

[Causes of Distortion on Radar Installation]

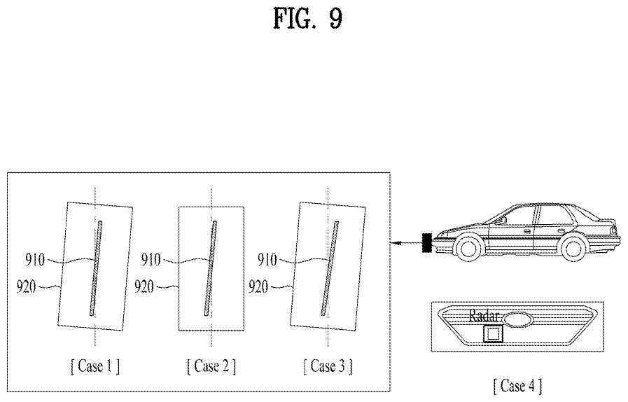

FIG. 9 is a diagram to describe the causes of distortion in installing a radar. Particularly, FIG. 9 shows a radar side view of an installed radar. Through Cases 1 to 4 shown in FIG. 9, the causes of distortion on radar installation are described.

Case 1 of FIG. 9 shows that a radar body 920 is distorted on vehicle installation despite that a radar internal PCB 910 is normally assembled to the radar body 920. Case 2 of FIG. 9 shows that the radar internal PCB 910 is assembled by being distorted despite that the radar body 920 is normally installed at the vehicle. Case 3 of FIG. 9 shows that the radar body 920 is installed on the vehicle by being distorted and that the radar internal PCB 910 is assembled by being distorted. Case 4 of FIG. 9 shows that a vehicle frame or bumper is distorted despite that the radar body 920 is normally installed on the vehicle and that the radar internal PCB 910 is normally assembled.

As described through Cases 1 to 4 of FIG. 9, a radar may be abnormally installed at a vehicle due to various causes. This may cause a problem that a radar is unable to detect an object normally due to distortion of a radio wave transmitted angle of a radio wave transmitting unit and distortion of a radio wave received angle of a radio wave receiving unit. Therefore, a technique of detecting a distorted angle (or error) on installing a radar at a vehicle and correcting the error is required.

[Alignment Method of Related Art]

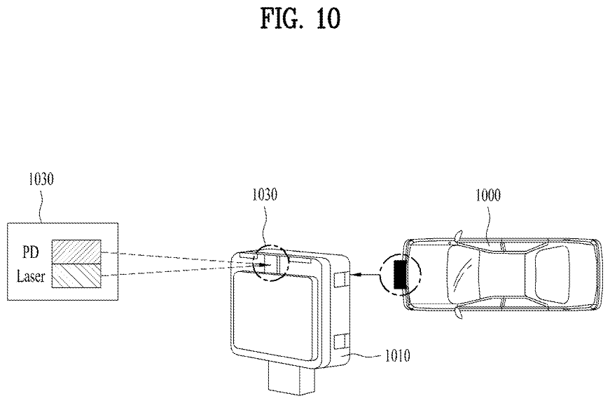

FIG. 10 is a diagram to describe one alignment method of the related art.

According to the related art shown in FIG. 10, a radar 1010 is installed at a vehicle 1000 first. While a located site of the vehicle 1000 is accurately leveled, a laser measurement module 1020 is disposed in a prescribed distance. Subsequently, the laser measurement module 1020 emits a laser and receives a beam reflected by a calibration mirror 1030 through a Photo Diode (PD). Finally, the distortion of the radar 101 is corrected through a radiation angle and a reception angle. In summary, the related art shown in FIG. 9 can be regarded as a method of physically correcting a distortion of the radar 1010 through the laser measurement module 1020.

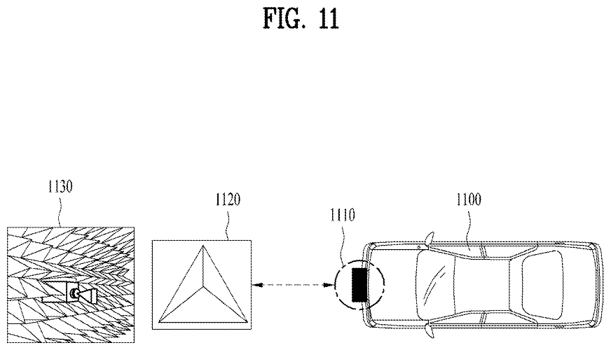

FIG. 11 is a diagram to describe another alignment method of the related art. The left side in FIG. 11 shows a corner reflector 1130 and an absorber 1130 enclosing the corner reflector 1120. The absorber 1130 prevents a radio wave from being reflected to a different target.

According to the related art shown in FIG. 11, a radar 1110 is installed at a vehicle 1000 first. While a located site of the vehicle 1000 is accurately leveled, the corner reflector 1120 is located in a prescribed distance. And, the distortion of the radar 1110 is corrected based on an Rx value of a radio wave received in a manner of being emitted from the radar 1110 and then reflected.

The related art shown in FIG. 11 is advantageous in using a space smaller than that of the related art shown in FIG. 10 but disadvantageously needs the front environment absorber 1130 for radio wave measurement.

[Radar Alignment Method According to the Present Invention]

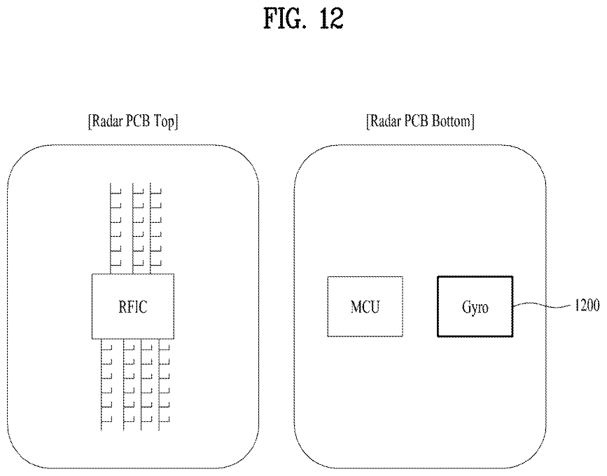

FIG. 12 is a diagram to describe a radar alignment method according to the present invention. Particularly, the left side in FIG. 12 shows a radar PCB top. And, Radio Frequency Integrated Circuit (RFIC) can be disposed on the radar PCB top. The right side in FIG. 12 shows a radar PCB bottom, on which MCU can be disposed.

According to one aspect of the present invention, Front-End Module (FEM) can be provided to a top of a radar PCB, i.e., an antenna board and Back-End Module (BEM), i.e., a signal processing board can be provided to a bottom of the radar PCB. So to speak, the FEM of the radar module may correspond to a Printed Circuit Board (PCB) top surface and the BEM of the radar module may correspond to a PCB bottom surface of the radar module. Thus, the radar PCB according to one aspect of the present invention can be implemented into a one-board including both an antenna board and a signal processing board.

Typically, the present invention proposes to apply a position sensor IC 1200 to an inside of a radar PCB. The position sensor 1200 may include a gyroscopic sensor or an acceleration sensor for example.

According to one aspect of the present invention, when a radar PCB is installed at a vehicle, how much an antenna of a board top is distorted can be detected through the position sensor 1200 provided to a bottom. Moreover, a radar alignment method according to one aspect of the present invention proposes to correct a distorted angle of an antenna by software.

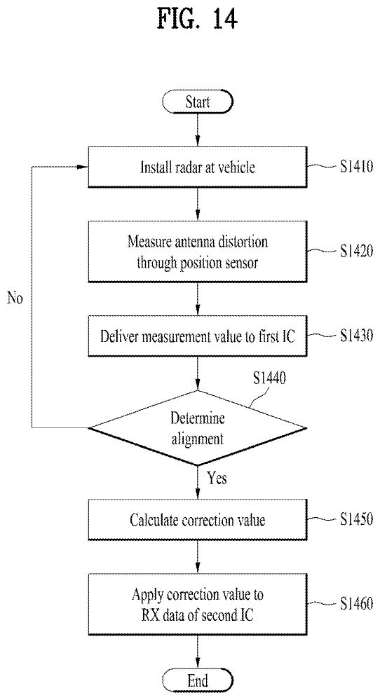

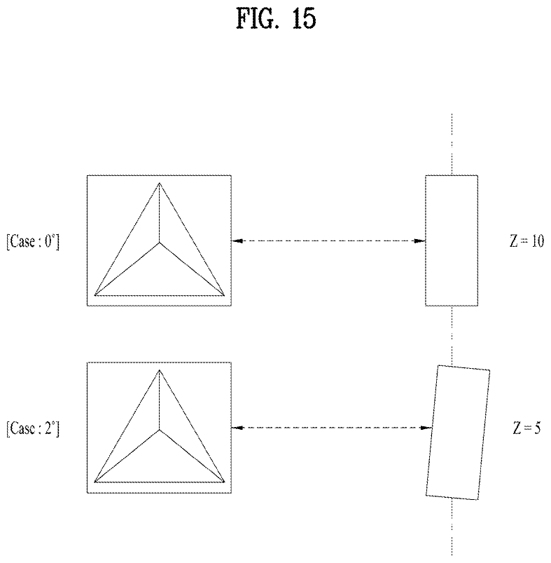

Meanwhile, in case that FEM and BEM are two boards implemented on separate boards, respectively, a measurement error of a position sensor located on the BEM may occur according to a connector coupled angle of the FEM and BEM. A method of correcting a distorted angle of an antenna by software shall be described with reference to FIG. 14 and FIG. 15.

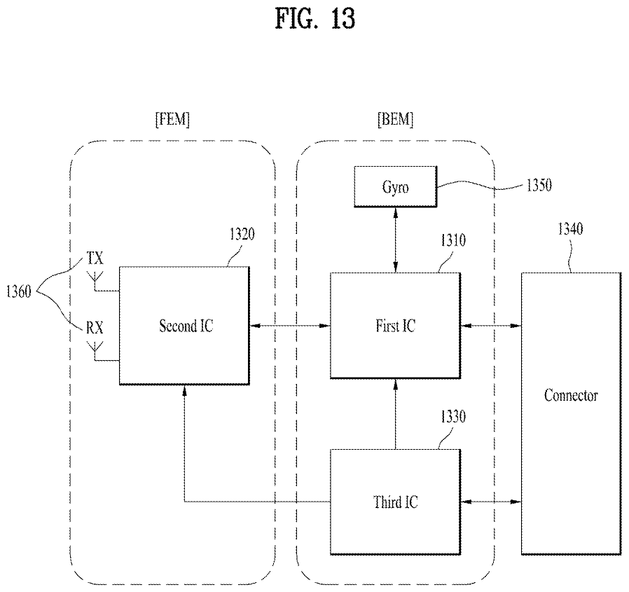

FIG. 13 is a block diagram of a system for implementing radar alignment according to one aspect of the present invention.

A first IC 1310 is a main processor chip (MCU) and may correspond to the MCU of the radar PCB shown in FIG. 12. A second IC 1320 is Monolithic Microwave Integrated Circuit (MMIC) and may correspond to the RFIC of the radar PCB shown in FIG. 12. The second IC 1320 can process data corresponding to a radio wave received through a radio wave receiving unit of an antenna 1360. A third IC 1330 is a chip for providing power to a system and may include System Basis Chip (SBC). Moreover, a connector 1340 connecting the respective ICs may be provided.

As described above, a radar PCB according to one aspect of the present invention may be a one-board in which Front-End Module (FEM) and Back-End Module (BEM) are implemented into a single board. Accordingly, the first IC 1310 and the third IC 1330 can be implemented on the BEM and the second IC 1320 may be implemented on the FEM.

Meanwhile, according to one aspect of the present invention, the antenna 1360 including the radio wave transmitting unit and the radio wave receiving unit may be included in the FEB. A position sensor 1350 can detect a distorted angle of the antenna 1360 provided to the FEM. Particularly, the position sensor 1350 can detect a distorted angle of a radio wave transmitting unit TX of the position sensor 1350.

As shown in FIG. 13, the position sensor 1350 may be disposed on the BEM. Yet, the scope of the appended claims and their equivalents the present invention is non-limited by disposing the position sensor 1350 on the BEM. For example, the position sensor 1350 may be disposed in a region having no interference with radio waves transmitted through the antenna 1360 in the region of the FEM.

FIG. 14 is a flowchart to describe radar alignment according to one aspect of the present invention. A radar alignment method according to one aspect of the present invention may include the following steps. Yet, some of the steps shown in FIG. 14 may be skipped, which comes within the scope of the appended claims and their equivalents.

In a step S1410, a radar (or a radar PCB) is installed at a vehicle. Particularly, the step of installing the radar at the vehicle includes a step of measuring a parameter value according to an angle distortion using a positioner in an RF chamber.

In a step S1420, antenna distortion is measured through a position sensor. In a step S1430, a value measured in the step S1420 is delivered to a first IC.

In a step S1440, the first IC determines alignment. Particularly, if a distorted angle of an antenna is smaller than a threshold (e.g., 3°), a step S1450 is executed. If the threshold is exceeded, the step S1410 can be executed again. Namely, if a prescribed condition is met, the first IC can calculate a correction value for correcting the distorted angle of the antenna.

In the step S1450, the first IC calculates the correction value for correcting the distorted angle of the antenna. In a step S1460, the correction value is applied to RX data of a second IC. Namely, the first IC delivers the calculated correction value to the second IC, thereby controlling the second IC to correct the data. In doing so, the correction value may be applied to an azimuth direction as well as to an elevation direction. The aforementioned steps S1450 and S1460 of FIG. 14 may be the steps performed in a process prior to releasing a vehicle.

Meanwhile, according to another aspect of the present invention, a correction value for correcting a distorted angle of an antenna can be calculated by real time in a state that a vehicle is driving or that an engine is running after a release as well as in the process prior to releasing the vehicle.

For example, the first IC receives a sensor value of a gyroscopic sensor included in Electronic Control Unit (ECU) of the vehicle through CAN and is able to additionally calculate a correction value for correcting a distorted angle of the antenna based on an angle corresponding to a difference between the sensor value of the gyroscopic sensor and the sensor value of the position sensor. According to another aspect of the present invention, distortion of a radar module can be corrected continuously after a release as well as in an assembly process for a vehicle release.

FIG. 15 is a diagram to describe distortion correction algorithm of radar alignment according to one aspect of the present invention. FIG. 15 is a diagram to describe the steps S1450 and S1460 of FIG. 14 in detail.

First of all, a parameter according to distortion per angle is measured with reference to a value at 0° on a radar assembly in an RF chamber. In doing so, a measured value may include a level corresponding to a power of a radio wave and a phase of the radio wave. And, a parameter according to angle distortion of a TX antenna is reflected for radar vehicle alignment.

Let's take FIG. 15 as an example, and assume that it is detected that a radar TX antenna is distorted by 2° through a position sensor. if a level value is Z=10 when a TX antenna angle is 0° on radar assembly, i.e., a reference angle and if a level value is Z=5 when the TX antenna angle is distorted by 2°, a correction parameter becomes 2 (=10/5) amounting to the very ratio, whereby 2 times is applied to a parameter of RX data [S1460 in FIG. 14]. Meanwhile, the aforementioned Z value is exemplary and may be expressed as a complex number of ‘a+jb’.

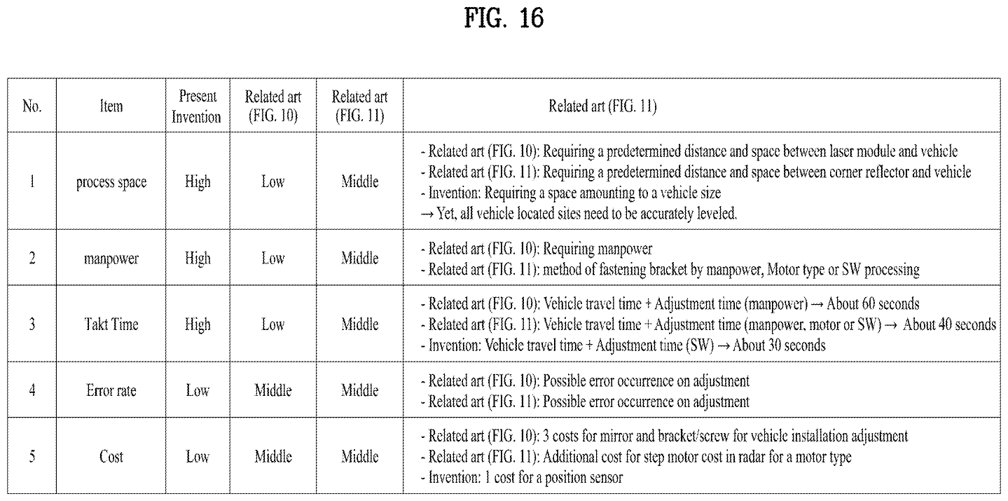

FIG. 16 is a table to compare a radar alignment process of the present invention with a related art radar alignment process.

In aspect of a process space, the related art according to FIG. 10 requires a predetermined distance and space between a laser module and a vehicle and the related art according to FIG. 11 requires a predetermined distance and space between a corner reflector and a vehicle. On the other hand, as the present invention requires a space corresponding to a size of a vehicle only, the present invention is more advantageous than the related art in the profess space aspect.

In aspect of manpower, the related art according to FIG. 10 requires manpower for controlling a laser module. And, the related art according to FIG. 11 uses a method of fastening a bracket with manpower or a motor method or software processing method that does not require manpower.

In aspect of Takt time, the related art according to FIG. 10 takes about 60 seconds including a vehicle travel time and an adjustment time. The related art according to FIG. 11 takes about 40 seconds including a vehicle travel time and an adjustment time. On the other hand, as the present invention applies correction algorithm by software, the present invention has an adjustment time shorter than those of the related arts, whereby about 30 seconds are taken.

In aspect of an error rate, in case of the related arts according to FIG. 10 and FIG. 11, since alignment is performed through manpower, an error rate on performing adjustment may be high. On the contrary, since correction algorithm is applied by software, the present invention can lower an error rate in comparison with the related arts.

Finally, in aspect of a price, the related art according to FIG. 10 requires about 3 costs for a mirror and a bracket and screw for vehicle installation adjustment. The related art according to FIG. 11 requires a cost corresponding to a step motor module in a radar in case of a motor type. On the contrary, since the present invention requires a cost for a position sensor only, the present invention is more advantageous than the related arts in aspect of costs.

Embodiments of the present invention can be implemented using various means. For instance, embodiments of the present invention can be implemented using hardware, firmware, software and/or any combinations thereof.

In case of the implementation by hardware, a method according to each embodiment of the present invention can be implemented by at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known to the public.

As mentioned in the foregoing description, the detailed descriptions for the preferred embodiments of the present invention are provided to be implemented by those skilled in the art. While the present invention has been described and illustrated herein with reference to the preferred embodiments thereof, it will be apparent to those skilled in the art that various modifications and variations can be made therein without departing from the spirit and scope of the invention. Therefore, the present invention is non-limited by the embodiments disclosed herein but intends to give a broadest scope matching the principles and new features disclosed herein. It will be appreciated by those skilled in the art that various modifications and variations can be made in the present specification without departing from the spirit or scope of the inventions. Thus, it is intended that the present specification covers the modifications and variations of this invention provided they come within the scope of the appended claims and their equivalents.

Both apparatus and method inventions are mentioned in this specification and descriptions of both of the apparatus and method inventions may be complementarily applicable to each other.

### MODE FOR INVENTION

Various forms for the embodiment of the invention are described in the best mode of the invention.

The above describe should not be restrictively interpreted in all aspects but considered exemplarily. Various modifications and variations can be made in the present invention without departing from the spirit or scope of the inventions, and the present invention covers the modifications and variations of this invention provided they come within the scope of the appended claims and their equivalents.

### INDUSTRIAL APPLICABILITY

The present invention mentioned in the foregoing description can be implemented in a program recorded medium as computer-readable codes. The computer-readable media may include all kinds of recording devices in which data readable by a computer system are stored. The computer-readable media may include HDD (Hard Disk Drive), SSD (Solid State Disk), SDD (Silicon Disk Drive), ROM, RAM, CD-ROM, magnetic tapes, floppy discs, optical data storage devices, and the like for example and also include carrier-wave type implementations (e.g., transmission via Internet). Further, the computer may include the controller of the wearable device. The foregoing embodiments are merely exemplary and are not to be considered as limiting the present disclosure. The present teachings can be readily applied to other types of methods and apparatuses. Thus, it is intended that the present invention covers the modifications and variations of this invention that come within the scope of the appended claims and their equivalents.

What is claimed is:

1. A radar module provided to a vehicle, the radar module comprising:
an antenna including a radio wave transmitting unit and a radio wave receiving unit;
a position sensor detecting a distorted angle of the antenna; and
a first Integrated Circuit (IC) connected to the position sensor,
wherein if a prescribed condition is met, the first IC calculates a correction value for correcting the distorted angle of the antenna.

2. The radar module of claim 1, wherein the prescribed condition is met if an angle detected through the position sensor is smaller than a threshold.

3. The radar module of claim 1, further comprising a second IC processing data corresponding to a radio wave received through the radio wave receiving unit, wherein the first IC delivers the calculated correction value to the second IC so as to control the second IC to correct the data.

4. The radar module of claim 1, wherein the position sensor comprises either a gyroscopic sensor or an acceleration sensor.

5. The radar module of claim 1, wherein the radar module comprises a Front End Module (FEM) and a Back End Module (BEM), wherein the antenna is disposed on the FEM, and wherein the position sensor and the first IC are disposed on the BEM.

6. The radar module of claim 5, wherein the FEM of the radar module corresponds to a Printed Circuit Board (PCB) top surface of the radar module and wherein the BEM of the radar module corresponds to a PCB bottom surface of the radar module.

7. The radar module of claim 5, further comprising:
a third IC for providing power to the radar module; and
a connector for connecting the first to third ICs.

8. The radar module of claim 1, wherein the first IC calculates the correction value for correcting the distorted angle of the antenna based on a ratio of a level of a radio wave received at a reference angle to a level of a radio wave received at an angle detected through the position sensor.

9. The radar module of claim 8, wherein the first IC additionally calculates the correction value for correcting the distorted angle of the antenna based on an angle corresponding to a difference between a sensor value of a gyroscopic sensor included in an Electronic Control Unit (ECU) of the vehicle and a sensor value of the position sensor.

10. A method of aligning a radar module provided to a vehicle, the method comprising:
detecting a distorted angle of an antenna including a radio wave transmitting unit and a radio wave receiving unit through a position sensor; and
calculating a correction value for correcting the distorted angle of the antenna through a first Integrated Circuit (IC) connected to the position sensor.

11. The method of claim 10, wherein the correction value is calculated if a prescribed condition is met and wherein the prescribed condition is met if an angle detected through the position sensor is smaller than a threshold.

12. The method of claim 10, further comprising:
delivering the calculated correction value to a second IC; and
correcting the data through the second IC.

13. The method of claim 10, wherein the correction value for correcting the distorted angle of the antenna is calculated based on a ratio of a level of a radio wave received at a reference angle to a level of a radio wave received at an angle detected through the position sensor.

14. The method of claim 13, wherein the correction value for correcting the distorted angle of the antenna is additionally calculated based on an angle corresponding to a difference between a sensor value of a gyroscopic sensor included in an Electronic Control Unit (ECU) of the vehicle and a sensor value of the position sensor.
